(19) United States
(12) Patent Application Publication
(10) Pub. No.: US 2012/0080375 A1
(43) Pub. Date: Apr. 5, 2012

(54) METHOD AND DEVICE FOR MANUFACTURING FILTERED LIQUIDS

(75) Inventors: Dirk Scheu, Amerdingen (DE); Albert Link, Au I.d.H (DE)

(73) Assignee: KRONES AG, Neutraubling (DE)

(21) Appl. No.: 13/249,602

(22) Filed: Sep. 30, 2011

(30) Foreign Application Priority Data
Sep. 30, 2010 (DE) DE102010041826.9

(51) Int. Cl. B01D 35/00

(52) U.S. Cl. 210/634; 210/409

(57) ABSTRACT

A method for producing filtered liquid, in particular sterile water, in a filtration device with at least one membrane unit during in each case a production cycle delimited by membrane backwash cycles of each membrane unit, in the production process at least one respective production liquid volume of a production cycle is temporarily stored before release for consumption until a verification of sterility has been obtained for the temporarily stored production liquid volume. In the device a membrane backwash system and a sterile-air test device are assigned to each membrane unit and at least one temporary store having a capacity corresponding at least to the production liquid volume arising during the production cycle is connected downstream.

### CROSS-REFERENCE TO RELATED APPLICATION

The present application claims the benefit of priority of German Application No. 102010041826.9, filed Sep. 30, 2010. The entire text of the priority application is incorporated herein by reference in its entirety.

### FIELD OF THE DISCLOSURE

The disclosure relates to a method and a device for producing a filtered liquid, such as by using a membrane unit.

### BACKGROUND

For various functions and processes, for example during the manufacture of beverages and in the bottling and packaging industries, sterile water is needed. Sterile water is often produced from raw water by the application of UHT/HTST technology, i.e. by the thermal heating of the raw water to guarantee the mortality of micro-organisms and subsequent cooling to the processing temperature. This is an extraordinarily energy-consuming and cost-intensive method. However, by monitoring the temperature it is relatively easy to ensure the permanent functional capability of the production plant, so that in the case of a malfunction no contaminated sterile water is released for consumption. To save energy and costs a possible alternative is membrane technology for producing sterile water of appropriate quality. Here, membrane units are employed through which the raw water is pumped in production cycles, whereby the membranes act as filters to retain micro-organisms and germs, thus rendering the water more or less sterile. The membranes of each membrane unit must for example be backwashed at regular intervals, whereby two consecutive backwash cycles and integrity tests temporally limit the production cycle. The production volume of sterile water from a production cycle has then however already been released for consumption or mixed with production volumes of other parallel operating membrane units and released for consumption. A disadvantage of membrane technology is however that so far it has not been possible to economically prove that the membranes remain functionally capable during each functional cycle. A membrane fracture or a membrane malfunction during a production cycle leads to sterile water of insufficient quality, which may then already have been used during the functions and processes, which implies complex and cost-intensive measures. This is because a disturbance of this nature is only found too late by a normal membrane integrity test after the production cycle.

From EP 1 189 684 B and US 2003 015977 A a drinking water dispenser for household water is known in which membrane functional tests are carried out during the operational procedure and if the result indicates a membrane fracture or a membrane malfunction, the production is stopped. The membrane unit is followed by a small reservoir from which the drinking water is taken. The purpose of the reservoir is to make a larger production volume and/or sufficient drinking water immediately available for a backwash cycle, because the membrane unit only has a limited supply performance. The consumption of contaminated drinking water cannot be prevented in this manner.

A similar problem occurs when apple juice, beer, etc. is filtered or cleared with microfiltration membranes. If “sterile” is applied here in the following, in each case it relates to a desired purity of the filtered liquid which is to be achieved based on the pore size of the filtration membrane used.

### SUMMARY OF THE INVENTION

One aspect of the disclosure is to provide a method of the type mentioned in the introduction and a device suitable for carrying out the method with self-monitoring of the maintenance of sterility (filter quality) of the liquid in order to be able to prevent consequential measures arising from the consumption of contaminated liquid.

Since according to the method verification of sterility is produced for the relevant membrane unit in the production sequence and in conjunction with a backwash cycle after a production cycle, but the production liquid volume is not released until verification of sterility is produced, but is rather temporarily stored, it is ensured that when a membrane fracture or a membrane malfunction occurs between consecutive integrity tests, the contaminated sterile water produced is not released for consumption, but rather can be discarded beforehand with a reasonable outlay of costs and energy. Due to the verification of sterility produced and the temporary storage before consumption, by using cost and energy-optimized membrane technology in a microfiltration device or an ultrafiltration device, the method has the important self-monitoring feature for ensuring sterility when consumed.

The combination of the filtration device with the backwash system, a sterile-air test device for the membrane functional capability of the relevant membrane unit and temporary storage with a predetermined capacity ensures maintenance of the sterility by self-monitoring. At least the capacity and optionally the structuring of the temporary store ensure that contaminated sterile water from the production process is not yet able to be passed on for consumption if it has not been possible to confirm the membrane functional capability. If necessary, contaminated sterile water produced between two consecutive backwash cycles and membrane functional capability tests (integrity test) is to be discarded. Optionally, a cleaning cycle is then carried out, which involves the temporary store but does not need to involve any consumers, and which therefore only causes a brief interruption in production.

According to the method, after each backwash cycle of a membrane unit a membrane functional test is carried out. Before each membrane functional test produced liquid is temporarily stored and only released for consumption once a positive result from the membrane functional test is available and thus the verification of sterility for the production cycle has been obtained.

Expediently, according to the method the membrane functional test is carried out as a bubble-point test with pressurized sterile air which is introduced after the backwash cycle, optionally with the membrane unit drained. Preferably, with the bubble-point test a pressure and/or volume measurement of the sterile air is carried out relative to a reference over time in which is it established how the introduced sterile air behaves in the membrane unit. For example, the sterile air is introduced at a pressure of about 1 bar, i.e. below the membrane pressure figure for bubble formation. It is found whether the through-flow or drop in pressure, for example, does not undercut a certain time window. By means of the bubble-point test a membrane functional disturbance or a membrane fracture can be quickly determined with reasonable outlay, which can be used to initiate the shut-down of the production process, at least for the affected membrane unit. The bubble-point test can be automatically initiated and evaluated routinely in conjunction with the backwash cycle in order to obtain the self-monitoring verification of sterility in the production process.

In order to achieve a required nominal performance in the production process, it is according to the method also expedient to carry out several parallel, optionally overlapping production cycles in several parallel membrane units. In this case sequential verifications of sterility for the production cycles are obtained and until obtaining the relevant verification of sterility the sum of the production volumes arising so far is temporarily stored. In this way it cannot actually be excluded that, for example, production volumes of perfectly acceptable sterile water are contaminated or at least partly contaminated by a production volume of contaminated sterile water. However, the temporary storage prevents, for example, contaminated sterile water being released as filtered liquid for consumption.

With a negative result from a conducted membrane functional test at least the content of the temporary store is discarded, because the negative result indicates a membrane fracture or a membrane functional disturbance. The membranes then namely pass the sterile air too quickly or in a too large an amount per unit time, which can be easily determined. Preferably, a cleaning cycle is then carried out, which includes at least the temporary store and the pipework up to the faulty membrane unit. In this way the required interruption of the production process can be relatively short, whereby it is decisive that no contaminated liquid has been released uncontrolled for consumption.

The production process is expediently controlled continuously or intermittently in consecutively following charges. With a continuous production process and with only one temporary store of sufficient capacity raw water can be passed by a single raw-water pumping station through the complete filtration device comprising several membrane units in parallel connection. The raw-water pumping station supplies, for example, raw water at a pressure of about 7 bar to the membrane units and pumps the sterile water produced, for example, at about 6 bar in and through the temporary store. With intermittent operation (batch principle) with a following temporary store the temporary store would only be released and opened after verification of sterility had been obtained. The temporary store would only then be refilled. In this case expediently several raw-water pumps are employed.

Expediently, also the production cycle of a relevant membrane unit of several parallel connected membrane units is at least set to a time period, during which backwash cycles can be carried out and verifications of sterility obtained sequentially in the other membrane units, as it were in turn. During the production cycle of a membrane unit the backwash cycles and membrane functional tests are carried out in turn in the other membrane units without temporarily stored, contaminated sterile water being able to be consumed. Due to a certain overhang or tolerance range provided on the control side, exceptions, such as backwash cycles possibly required earlier in individual membrane units cannot disturb the balance of this operational procedure. Also to ensure the required nominal supply of sterile water, backwash cycles of this nature which are required earlier can be taken as an inducement to carry out major cleaning, because they are an indication of a generally decreasing performance capability.

In order to achieve a relatively high nominal performance with the filtration device, several parallel membrane units are provided and connected to a raw-water pumping station and the temporary store. The capacity of the temporary store corresponds at least to the sum of the production volumes of all membrane units during the production cycle of a relevant membrane unit or at least to the sum of the production volumes of those membrane units on which no membrane functional test is currently being carried out. To be on the safe side, preferably the capacity of the temporary store even corresponds to the sum of the production volumes of all membrane units for the time period of the production cycle of a relevant membrane unit in addition to the time period of a backwash cycle and of a membrane functional test, carried out in conjunction with the backwash cycle, for obtaining verification of sterility for this membrane unit. The capacity of the temporary store can alternatively also be dimensioned somewhat smaller if the temporary store is formed such that it ensures predetermined layering for the produced sterile water, due to which following contaminated sterile water or its water front does not advance with non-contaminated sterile water into layers positioned in the vicinity of the consumer. This is because the production volume from the production cycle of the malfunctioning membrane unit is then one of the last in the temporary store, whereas the previously introduced production volumes contain not contaminated sterile water.

Expediently, the sterile-air test device is formed for the membrane functional capability such that with the sterile air, which is introduced into the relevant membrane unit at a pressure, a bubble-point test can be carried out which quickly supplies either the verification of sterility so that the production process can continue unchanged or signals a membrane malfunction which can be used to initiate the interruption of the production process.

In a practicable embodiment the temporary store is a tank with the required capacity. The tank can be either a simple tank without any built-in features. Preferably, the tank is formed with an inlet situated at the bottom and an outlet situated at the top. Expediently, built-in features are in fact provided in the tank, such as inlet pots and/or guide panels in order to force predetermined sterile water layering between the inlet and outlet.

Alternatively, the temporary store can comprise at least one pipe coil.

In a further, expedient embodiment the temporary store comprises at least two partial stores, for example in the form of tanks or pipe coils, in which liquids produced during the filtration, e.g. sterile water, can be alternatively introduced. Expediently, each partial store has the required capacity with which it is ensured that produced sterile water is only released for consumption when the verification of sterility has been obtained. If a partial store with contaminated sterile water and the membrane unit responsible for this are isolated, the production plant can be operated further with the other partial store and integral membrane units.

Basically, it may be expedient, especially for a continuous operational process, to connect the several membrane units to one common single raw-water pump. The filtration device can thus be operated with a reasonably small energy outlay.

With a temporary store, which has at least two parallel connected, alternatively feedable partial stores, it may be expedient to provide double pipework between the membrane units and the temporary store. This double pipework includes reciprocal lateral connections and changeover members. Optionally, the backwash systems are also doubly present in order to take into account aseptic and recontamination aspects. For the case that the verification of sterility could not be obtained, the affected partial store is drained and the other partial store selected. Using the changeover members and the reciprocal lateral connections, a more secure flow path can be set up both for backwash cycles and also production cycles while the contaminated partial store and the contaminated pipework sections are drained and cleaned.

Finally, the filtration device expediently has a production control and monitoring device, which can be computerized, and is connected at least to function-monitoring sensors on or in the relevant membrane unit. Also, the membrane functional capability tests can be controlled and evaluated via the production control and monitoring equipment, as can the backwash cycles, and namely expediently in turn or sequential.

### BRIEF DESCRIPTION OF THE DRAWINGS

Embodiments of the disclosure are described based on the drawing. The following are shown:

FIG. 1 a schematic illustration of an ultrafiltration device for the production of sterile water,

FIG. 2 schematically a larger ultrafiltration device for clarification of the production process, and

FIG. 3 a schematic illustration of a detailed variant of an ultrafiltration device.

### DETAILED DESCRIPTION OF THE PREFERRED EMBODIMENT

The disclosure is explained and described in the following with reference to an ultrafiltration device for the manufacture of sterile water, but the embodiments apply equally to membrane filtration generally and also particularly include microfiltration devices with which, for example, apple juice, beer or similar liquids are filtered or clarified.

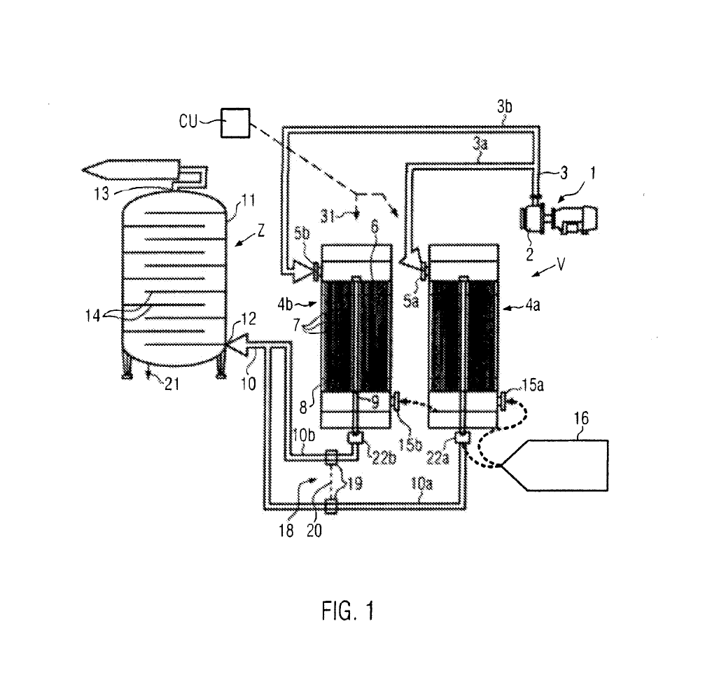

An ultrafiltration device V in FIG. 1 comprises as the main components a raw-water pumping station 1, at least one membrane unit 4a or 4b, in the illustrated case at least two parallel connected membrane units 4a and 4b and a temporary store Z for sterile water manufactured in the production process.

In the raw-water pumping station 1, for example for a continuous production process, a single raw-water pump 2 is provided, which pumps raw water via pipework 3 and parallel branch lines 3a, 3b to the inlets 5a, 5b of the membrane units 4a, 4b. In each membrane unit 4a, 4b, for example, an upper potted inlet 6 and a low lying potted outlet 8 is provided with intervening membranes 7, as well as a central collecting pipe 9 for sterile water produced from the raw water via the membranes 7. Through flow from top to bottom is not essential. The membranes 7 do not need to be constructed standing (alternatives: RO system, UF system with bobbin modules).

Parallel pipes 10a, 10b connect the collecting pipes 9 to a pipe 10, which leads to an inlet 12 of the temporary store Z. The temporary store Z is, for example, a tank 11, which can be designed either without built-in features or as shown equipped with built-in features 14, such as for example inlet pots (not shown) or flow guide panels, which force layering of the introduced sterile water between the low lying inlet 12 shown here and an outlet 13 positioned at the top. The outlet 13, which can be provided with a shut-off member, is, for example, connected to consumers which are not shown.

A further equipment component of the ultrafiltration device V is an optionally common sterile air test device 16, with which via monitoring of the pressure or of the volume over time pressurized sterile air, e.g. at 1 bar, can be fed alternatively to a connection 15a, 15b of each membrane unit 4a, 4b, for carrying out a membrane functional capability test. Furthermore, a backwash system 18 is provided for each membrane unit 4a, 4b, with which a backwash cycle can be carried out in the relevant membrane unit before and after a production cycle. A membrane functional capability test is carried out by means of the sterile-air test device 16 in conjunction with a backwash cycle, expediently after the backwash cycle and draining of the membrane unit. In the illustrated embodiment each backwash cycle is carried out with sterile water which originates from the production cycle of at least one membrane unit 4a or 4b. For this purpose shut-off members 19 and a bypass line 20 can be provided between the pipes 10a, 10b. Alternatively, an independent backwash circuit could also be provided for each membrane unit 4a, 4b. Optionally, shut-off members 22a, 22b are provided for each membrane unit 4a, 4b, as also optional shut-off members on the inlets 5a, 5b (not shown). The tank 11 can be fitted with a discard outlet 21 at the bottom. Furthermore, the membrane units 4a, 4b, pipes 10a, 10b, 10 and the tank 11 can be connected to a cleaning system which is not illustrated.

If only one membrane unit 4a or 4b is provided, then the temporary store Z has a capacity corresponding at least to the production volume of a production cycle of the membrane unit 4a or 4b. If several membrane units operate simultaneously, the temporary store Z on the other hand has a capacity corresponding to the production volumes, which arise during a production cycle in addition to the volume of sterile water arising during a backwash cycle and the membrane functional capability test.

The filtration device, here for example the ultrafiltration device, is assigned a production control and monitoring device CU, preferably a computerized device with input and display sections, which can at least be connected to function-monitoring sensors 31 connected to or in the membrane units 4a, 4b.

In the embodiment in FIG. 1 a continuous production process is possible with only one single raw-water pump 2, which for example supplies the raw water with a pressure of about 7 bar and due to the functionally induced pressure loss in the membrane units 4a, 4b delivers sterile water into the temporary store Z at about 6 bar. The volume of sterile water temporarily stored in the temporary store Z is then only released for consumption when verification of sterility has been obtained by a successfully completed membrane functional capability test. If the verification of sterility cannot be obtained, because the test, for example, indicates a membrane fracture or a membrane malfunction, the temporarily stored sterile water is not released for consumption, but discarded instead and the operational procedure is interrupted and expediently a cleaning cycle or partial cleaning is carried out.

To obtain the verification of sterility sterile air is fed in after a backwash cycle, optionally with drained membrane unit 4a or 4b and continuing running production cycle of each further membrane unit 4a or 4b and a measurement carried out (bubble-point test) of how the drop in pressure of the sterile air or its introduced amount behaves over time. A predetermined time window is considered. If this time window is undercut, for example the pressure of the sterile air decays too quickly or the sterile air flows through too quickly, then this is taken as an indication that a membrane fracture or a membrane malfunction is present. If the time window is maintained, then this is assessed as verification of sterility and the tested membrane unit is again put into operation.

According to the method, it is determined, for example, where the position of the front of the sterile water flow lies at the start and on switching over to backwash cycles, whereby it is ensured that the front does not leave the temporary store before verification of sterility has been obtained. The sterile water must not have left the temporary store until at least the second verification of sterility has been obtained in each case for each membrane unit. This requires a certain dwell time of the produced sterile water in the temporary store and appropriate dimensioning of the temporary store. The temporary store could, amongst others, also be a pipe coil.

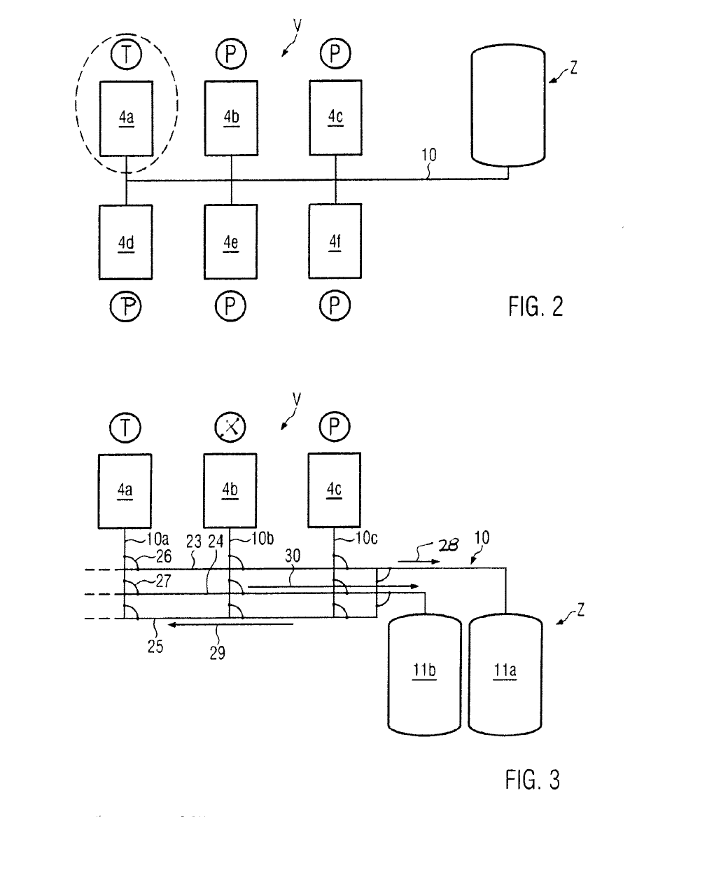

For each membrane unit there are four different operating states (FIG. 2, FIG. 3):

T=T1=membrane functional test of a membrane unit before a production cycle (backwash cycle+membrane functional test+production preparation)

X=preparation status (i.e. the membrane unit is intact and in the waiting position)

P=production cycle

T=T2=membrane functional test of the membrane unit before the next production cycle (backwash cycle+membrane functional test+production preparation of the membrane unit)

Since generally a new production cycle runs after T2, for this case T2 again becomes T1.

The maximum total dwell time of the sterile water in the temporary store Z for an ultrafiltration device with at least two parallel membrane units 4a, 4b is then

tₜₒₜₐₗ=t_{production cycle}+t_{T2}

For a maximum volume flow this gives the minimum capacity of the temporary store with

V_{volume of temporary store}=\dot{V}ₘₐₓ·tₜₒₜₐₗ

The membrane area dimensioning is given by

\dot{V}=Permeability·Membrane area

and is dependent on the required overhanging production for tₜₒₜₐₗ and in the illustrated embodiment in FIG. 1 leads to

$${\dot{V}}_{no min alperformance / net} = \frac{1}{No . of membrane units} \cdot {\dot{V}}_{total performance / gross}$$

With the illustrated embodiment in FIG. 1 and also in the embodiment in FIG. 2 with for example six parallel membrane units 4a-4f preceding the temporary store Z the time period of a production cycle of a membrane unit is set such that in turn all membrane units can be tested and washed. Exceptions due to any backwash cycles which become necessary earlier with single membrane units (e.g. after finding decreased filtration performance or inadmissibly increasing pressure difference) cannot disturb the operational procedure due to a predetermined overhang. Backwash cycles of this nature which become necessary earlier than predetermined can with more frequent occurrence rather be taken as an inducement for major cleaning and/or a change of membrane in the ultrafiltration device V.

Basically, a continuous operational procedure is expedient with the advantage of managing with a single raw-water pump 2, which introduces raw water for example at about 7 bar and, due to the pressure drop in the membrane units 4a-4f for example delivers sterile water at about 6 bar in or through the temporary store Z.

Alternatively, also a batch system with at least one temporary store could be expedient, which produces charges intermittently. In this case the temporary store would only be released and opened after obtaining the verification of sterility at T2 and it could also only then be filled again. In this case with several membrane units several raw-water pumps would be required.

With the ultrafiltration device V in FIG. 2 indicated in the production process with for example six membrane units 4a-4f (or membrane banks) membrane unit 4a, for example, goes through a membrane functional capability test T, while the other membrane units 4b-4f go through their production cycles P. From the start of the production process, for example, a delivery rate of approximately 10 m³/h of sterile water is achieved. After a time period of about 90 minutes, for example, a start is made with a backwash cycle in each module unit 4a-4f in turn and in each case a membrane functional capability test is carried out following the backwash cycle. The backwash cycle and the test take, for example, approximately 14 minutes. That is, in the production process each membrane unit is backwashed and tested once within the production idle time of for example 90 minutes and on obtaining verification of sterility again coupled into the production process before transfer takes place to the next membrane unit to backwash it and test it. Here, an overhang of about 6 minutes is present. The backwash amount can be taken from the production volumes of other membrane units. This may mean that the gross production performance corresponding to the backwash amount is higher and can be regulated, so that the required nominal performance of for example 10 m³/h always occurs. If required, the maximum nominal performance can be flexibly and alternatively reduced. A negative result of a membrane functional capability test results in the immediate cessation of the production process. Expediently, the temporary store and also the pipework is then drained and then cleaned.

FIG. 3 illustrates an embodiment of an ultrafiltration device V with for example at least three membrane units 4a-4c connected in parallel and pipework 10 to the temporary store Z, which in FIG. 3 consists of at least two alternatively feedable tanks 11a, 11b (or pipe coils, not shown). Each tank 11a, 11b has a capacity which facilitates the temporary storage of at least the sum of the production volumes of the membrane units 4a, 4c which have been produced between two consecutive tests. In this case it is expedient to form the pipework 10 as a multiple, for example doubled or in two lines, so that when a membrane malfunction or a membrane fracture in a membrane unit 4a-4c is found, the membrane units continuing to produce sterile water can be switched over to a secure flow path. The contents of the pipework sections used to this point and of a tank 11a or 11b can be discarded, before cleaning takes place here.

In the case illustrated in FIG. 3 parallel connecting lines 23, 24 are provided in each case to a tank 11a, 11b to which the pipes 10a, 10b, 10c of the membrane units 4a-4c are connected. Furthermore a backwash line 25 is provided to which all membrane units 4a-4c are similarly connected. Between the lines 22, 24, 25 and the lines 10a, 10b and 10c lateral connections 26 are expediently provided with shut-off members 27. In the operational procedure indicated in FIG. 3 a test T is being carried out for the membrane unit 4a. Simultaneously, the membrane unit 4b is in the preparation state X. The membrane unit 4c is carrying out its production cycle. The produced sterile water passes along the flow path 28 to the tank 11a. For backwashing the membrane unit 4a, for example, the flow path 29 has been used. If now a membrane malfunction is found in the membrane unit 4a during the test T, then the shut-off members 27 are controlled such that the membrane units 4c and 4b are switched to the secure flow path 30 (a segment of the pipe 24) to the other tank 11b, whereas the previous flow path 28 (optionally also the backwash flow path 29) is isolated. The content of the tank 11a and the associated pipe segments is discarded, whereas sterile water continues to be produced, temporarily stored in the tank 11b and only released for consumption, if the next following membrane functional capability test produces a verification of sterility.

Summarizing, with the method according to the disclosure and in the filtration device V formed according to the disclosure the advantage of membrane technology, i.e. the reduced cost and energy outlay, can be used for the production of sterile water, but also for filtration or clarification with microfiltration membranes, especially for functions and processes in the manufacture of beverages and for bottling or packaging techniques, and due to on-line self-monitoring of the method and the filtration device V it is ensured that no contaminated sterile water and no contaminated liquid pass for consumption. Here, the bubble-point test is a cost-effective and reliable procedure for obtaining the verification of sterility, although it cannot be excluded that the verification of sterility is obtained in a different manner.

1. Method for producing filtered liquid for use in the manufacture of beverages or in the bottling or packaging industries, the method comprising in a filtration device with at least one membrane unit during in each case a production cycle delimited by membrane backwash cycles, and in the production process temporarily storing before release for consumption at least one respective filtered production liquid volume of a production cycle until a verification of sterility has been obtained for the temporarily stored production liquid volume.

2. The method according to claim 1, and, after a backwash cycle of a membrane unit, carrying out a membrane functional test for the membrane unit, and releasing at least the temporarily stored production liquid volume for consumption only when a positive result of the membrane functional test is available, and discarding the temporarily stored production liquid volume if verification of sterility is not obtained.

3. Method according to claim 2, and carrying out the membrane functional test as a bubble-point test with pressurized sterile air for finding a membrane fracture or a membrane malfunction.

4. The method according to claim 1, and, in the production process with several parallel production cycles producing, obtaining sequentially in each case a production liquid volume from a membrane unit the verifications of sterility for all the membrane units, and, until the respective verification of sterility is obtained, temporarily storing all the production liquid volumes arising up to that point.

5. The method according to claim 2, and, with a result of a membrane functional test confirming a membrane fracture or a membrane malfunction, discarding the liquid temporarily stored in a temporary store or a partial store of a temporary store comprising at least two partial stores.

6. The method according to claim 1, and carrying out the production process continuously or intermittently in consecutive charges.

7. The method according to claim 1, and setting at least one time period for the production cycle of a respective membrane unit of several parallel membrane units, during which backwash cycles can be carried out and verifications of sterility can be obtained sequentially in the other membrane units.

8. Filtration device for producing filtered liquids, which are in each case pumped in a production cycle and are intended for use in the manufacture of beverages or in the bottling or packaging industries, the device comprising at least one membrane unit having a membrane backwash system and a sterile air test device for membrane functional tests assigned thereto, and a temporary store downstream of there sterile air test device, the temporary store having a capacity at least corresponding to the production liquid volume arising during a production cycle of the at least one membrane unit.

9. The filtration device according to claim 8, wherein a plurality of membrane units are provided and connected to a pumping station and are connected in parallel to the temporary store, the capacity of the temporary store corresponding at least to the sum of the production liquid volumes of the plurality of membrane units during the production cycle of a respective membrane unit.

10. The filtration device according to claim 8, wherein the sterile-air test device is configured to perform a bubble-point test in each case with sterile air, pressurized to a predetermined level, introduced into the respective membrane unit.

11. The filtration device according to claim 8, wherein the temporary store comprises at least one tank.

12. The filtration device according to claim 8, wherein the temporary store comprises at least one pipe coil.

13. The filtration device according to claim 11, wherein the temporary store comprises at least two feedable tanks as one of partial stores, pipe coils, and a combination thereof each feedable tank having a capacity at least corresponding to the production liquid volume of one of a membrane unit or to the sum of the production volumes of producing membrane units during a production cycle.

14. The filtration device according to claim 9, wherein the membrane units are connected to one of a common single pump or pumping station.

15. The filtration device according to claim 13, wherein, with a temporary store having at least two alternatively feedable partial stores for several parallel producing membrane units, multiple pipes are provided between the membrane units and the partial stores, with reciprocal lateral connections with changeover members for changing over to a safe flow path from flow paths identified as safe and unsafe after a result of a membrane functional test on a membrane unit confirming a membrane fracture or a membrane malfunction.

16. The filtration device according to claim 8, and wherein a production control and monitoring device is provided and is connected at least to function-monitoring sensors one of on or in the respective membrane unit.

17. The method according to claim 1, wherein the produced filtered liquid is sterile water.

18. The method according to claim 2, wherein the membrane functional test is an integrity test.

19. The method according to claim 3, and, with the membrane functional test relative to a reference, carrying out over time a pressure and/or volume measurement of the sterile air, the pressure of which is set below the bubble formation pressure value of the membranes.

20. The method according to claim 5, and carrying out cleaning of the temporary store or of the relevant partial store and at least one pipe leading up to the malfunctioning membrane unit.

21. The filtration device according to claim 8, wherein the produced filtered liquid is sterile water.

22. The filtration device according to claim 9, wherein the plurality of membrane units are in parallel.

23. The filtration device according to claim 9, and wherein the capacity of the temporary store corresponds to the sum of the production liquid volumes of producing membrane units for the time period of the production cycle of a respective membrane unit plus the time period of a backwash cycle and of a membrane functional test carried out in conjunction with the backwash cycle

24. The filtration device according to claim 11, and wherein the tank has an inlet situated at the bottom and an outlet situated at the top and built-in features

25. The filtration device according to claim 24, wherein the built-in features comprise one of inlet pots, guide panels, and a combination thereof for layering the liquid between the inlet and outlet.

26. The filtration device according to claim 15, wherein the multiple pipes comprise double pipes.
